(19) United States
(12) Patent Application Publication
(10) Pub. No.: US 2023/0294306 A1
(43) Pub. Date: Sep. 21, 2023

(54) Visual-Tactile Sensing Device for Use in Robotic Gripper

(71) Applicant: ABB Schweiz AG, Baden (CH)

(72) Inventor: Nolan W. Nicholas, West Lafayette, IN (US)

(73) Assignee: ABB Schweiz AG, Baden (CH)

(21) Appl. No.: 18/018,780

(22) PCT Filed: Jul. 30, 2020
(86) PCT No.: PCT/US2020/044219

§ 371 Date: Jan. 30, 2023

(51) Int. Cl. B25J 15/08; B25J 13/08; G01L 5/22; G01L 1/24

(52) U.S. Cl. CPC B25J 15/08; B25J 13/084; G01L 1/241; G01L 5/226

(57) ABSTRACT

A robotic gripper includes a number of fingers useful to grasp a work piece. Each finger can include a visual-tactile contact pad useful to provide contact information related to the work piece when it is grasped by the fingers. The hand and fingers of the robotic gripper can include one or more optical elements such as mirrors/lenses/etc which aid in transmitting optical information from the pad to a camera. A single image sensor can be used to capture the optical data originating from the different pads. The different pads can be configured to project unique wavelengths to permit simultaneous imaging by the single image sensor. The optical paths can be configured to image on different portions of the image sensor to permit simultaneous imaging. In still other forms a shutter or similar device can be used to alternate projection of image data onto the image sensor from the different pads.

### TECHNICAL FIELD

The present disclosure generally relates to robotic grippers, and more particularly, but not exclusively, to robotic grippers that incorporate visual-tactile sensing devices.

### BACKGROUND

Providing tactile information during robotic manipulation of a work piece remains an area of interest. Some existing systems have various shortcomings relative to certain applications. Accordingly, there remains a need for further contributions in this area of technology.

### SUMMARY

One embodiment of the present disclosure is a unique robotic gripper. Other embodiments include apparatuses, systems, devices, hardware, methods, and combinations for determining tactile information and proximity of work piece with respect to a robotic gripper. Further embodiments, forms, features, aspects, benefits, and advantages of the present application shall become apparent from the description and figures provided herewith.

### BRIEF DESCRIPTION OF THE FIGURES

FIG. 1 depicts an embodiment of a visual-tactile sensing device in proximity to a work piece.

FIG. 2 depicts an embodiment of a visual-tactile contact pad.

FIG. 3 depicts another embodiment of a visual-tactile contact pad.

FIG. 4 depicts another embodiment of a visual-tactile contact pad.

FIG. 5 depicts another embodiment of a visual-tactile contact pad.

FIG. 6 depicts another embodiment of a visual-tactile contact pad.

FIG. 7 depicts an embodiment of a robotic gripper.

FIG. 8 depicts another embodiment of a visual-tactile contact pad.

FIG. 9 depicts another embodiment of a visual-tactile contact pad.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

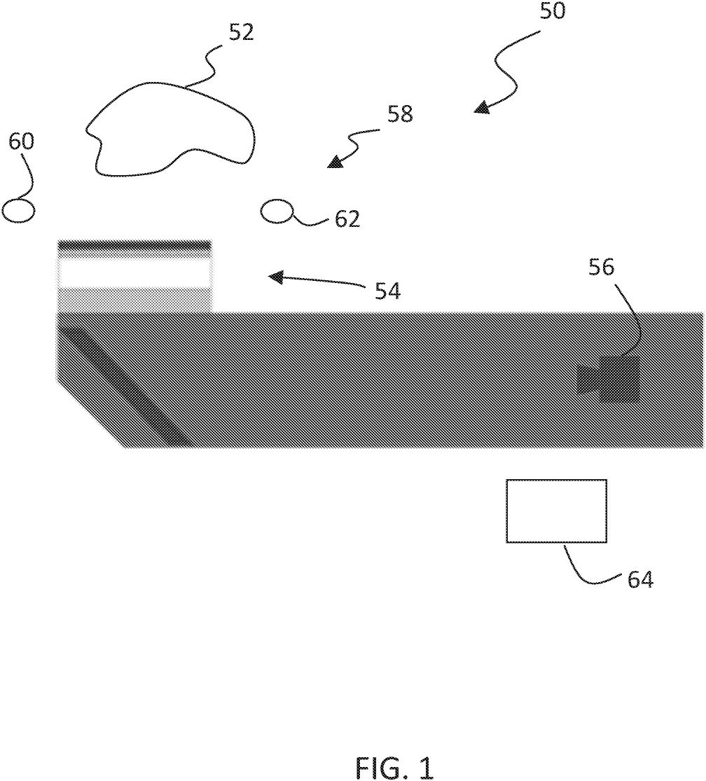

With reference to FIG. 1, a visual-tactile sensing device 50 is illustrated and is useful for sensing a work piece 52 as it approaches and eventually contacts a visual-tactile contact pad 54 of the device 50. The visual-tactile contact pad 54 is made of a number of pliable layers which deform when contacted under force by the work piece 52. Deformation of the pad 54 causes a change in light coming from the pad 54 which can be sensed by the camera 56. Aiding the camera in detecting light changes is a lighting system 58 which in the illustrated embodiment includes a first light source 60 and a second light source 62 but will be understood to include any different number of light sources. Although the camera is depicted as being displaced from the pad 54 it will be appreciated that it can be placed in other locations. Further, the lights of the lighting system 58 are shown as being displaced to the side of the pad 54 and/or imaging scene of the camera 56, but other locations are also contemplated herein. A controller 64 can be included to regulate actions of the lighting system 58, the camera 56, and/or a device used to change position or orientation of the work piece 52. For example, in some forms the visual-tactile sensing device can be incorporated into a robotic system in which a gripper or the like is formed to include the pad 54. The controller 64 can alternatively and/or additionally be used to estimate contours of the work piece 52 and/or forces used to impress the work piece into the pad 54. Embodiments will be described below with respect to the pad 54 and various different characteristics, but it will be appreciated that all can be incorporated into the embodiments discussed with respect to FIG. 1.

In more specific details, the present application provides for the use of a tactile sensor possessing a deformable surface structure wherein the deformation of the surface structure by contacting objects may be imaged by a proximate camera and wherein images may also be obtained through this surface structure to observe objects and features which are not in contact with the surface layer. Typically the deformable surface structure (e.g. the pad 54) will be substantially transparent and possess a coating at or near its surface which is reflective and possesses known optical characteristics so that the shape of this surface layer may be imaged directly without complication from unknown optical characteristics. This provides the system the ability to both sense objects in contact with the sensing surface and forces resulting therefrom and also the ability to sense objects and features that are beyond the surface of the sensor body. This enables enhanced sensing for applications such as robotic manipulation, metrology and surface measurement and characterization.

In the embodiments disclosed herein a sensor can be constructed utilizing a layer of deformable material possessing a top-coat which is substantially reflective for incident lighting with certain properties and substantially light-transmitting for incident lighting with different properties and a camera and lighting system which is placed behind this layer. When objects (e.g. the work piece 52) come into contact with the top of the pad 54 it causes deformation to the deformable material and top-coat of the pad 54 which is in turn imaged by the camera 56 and lighting system 58 using reflected light and optical features of objects both in direct contact with said structure and beyond said structure are imaged using transmitted light. Deformable materials include various materials such as are known in the art including siloxanes such as PDMS, soft polyurethanes, etc.

The performance of the pad 58 to control optical properties which return light to the camera system enable the computer imaging system (e.g. the controller 64) to more effectively image and calculate the geometric features corresponding to the surface deformation. In the present application the surface layer is constructed to return some of the light to the camera system from the surface layer and to let some light through in such a way that the light which is returned from the surface reflective layer can be substantially differentiated from light that that is transmitted through the surface layer.

In one or more of the embodiments herein such differentially distinguishable light signals can be created through a variety of mechanisms. For instance:
light of certain spectra may be preferentially transmitted while light of other spectra is reflected;
light of certain spectra may be eliminated from the transmitted signal and light corresponding to this spectrum may be generated by the surface layer (e.g. by fluorescence);
light of certain polarization characteristics may be transmitted while light of different polarization characteristics;
scattering corrected imaging (e.g. using coherent light illumination & wavefront corrected transmission); and
time-sequential varied illumination with comparative image subtraction (e.g. blinking the internal illumination light and comparing the images produced by internal illumination on vs internal illumination off conditions).

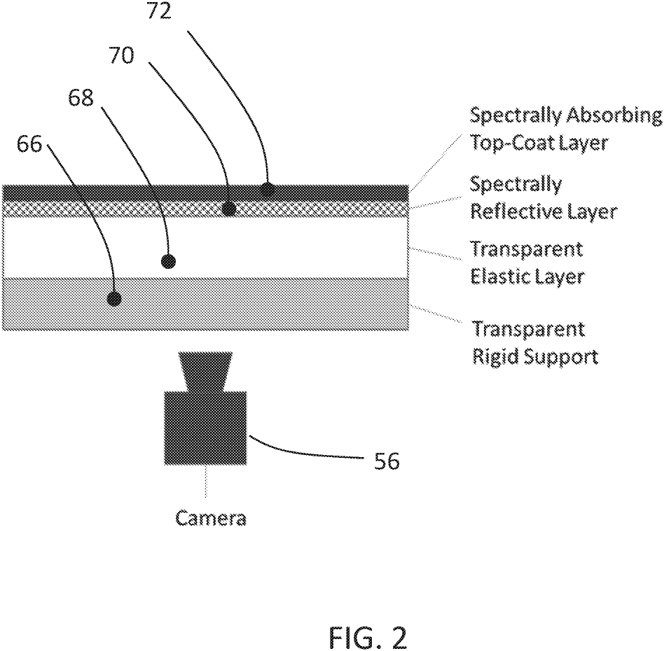

Turning now to FIG. 2, the visual-tactile contact pad 54 may be constructed in such a way that certain wavelengths of light are substantially transmitted while other wavelengths of light are substantially reflected and/or scattered back towards the camera. For instance, it is known that optical interference effects may be used to provide filtering effects which act to transmit certain wavelengths of light while transmitting other wavelengths. Such interference effects can be achieved in various ways including:
1. substantially contiguous thin-films such as are commonly used in consumer optics to form anti-reflection coatings and in optics to form wavelength selective filters
2. interference-based wavelength selective pigments which are commonly constructed as small flakes (commercially available examples include Xirallic from Merck KGaA, Iriodin from Merck Global, Pyrisma from Merck KGaA, and the like)

In embodiments disclosed herein, a layer may be included on top of the wavelength-selective reflective layer which acts to absorb some portion of the optical wavelengths which are reflected by the interference-reflective layer (e.g. a layer of dye dissolved in polymer) while allowing other wavelength spectra to pass through. This acts to enhance the spectral selectivity of such embodiments.

Embodiments disclosed herein include a rigid base 66, elastic layer 68, light layer 70, and spectrally absorbing layer 72. Although the camera 56 in FIG. 2 is shown oriented to capture a direct image of the pad 54, other embodiments can include the camera 56 displaced relative to the pad 54 and may be provided an image through reflective techniques (e.g. mirrors) or through a fiber optic cable. Such variations also apply to all other embodiments disclosed herein.

As will be understood, the term “camera” can refer to a variety of devices capable of detecting electromagnetic radiation, whether in the visible range, infrared range, etc. Such “cameras” can also refer to 2D and/or 3D cameras.

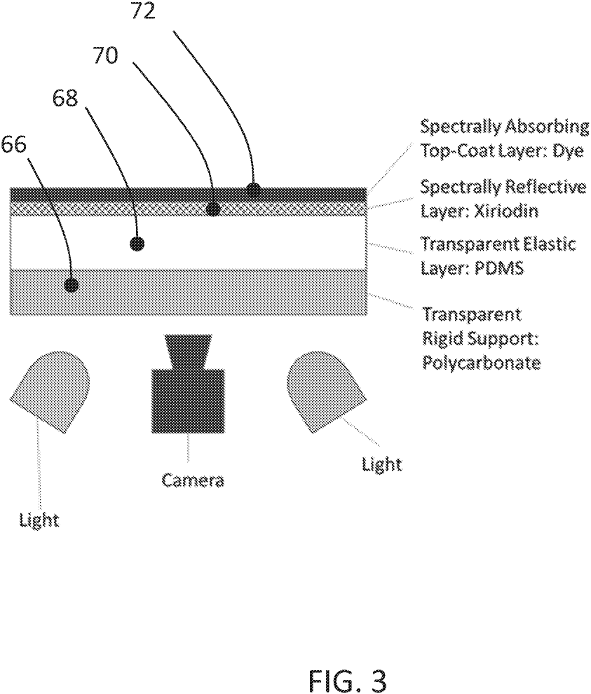

FIG. 3 depicts the sensing device 50 with a lighting system 58. Shown in FIG. 3 is the camera 56 and lighting system 58 positioned beneath the rigid base 66. In the illustrated embodiment the rigid base 66 takes the form of a hard, transparent plate of polycarbonate which supports the elastic layer 68. The rigid base 66 can take other forms as will be appreciated. The elastic layer 68 takes the form of a deformable film of polydimethylsiloxane (PDMS). The elastic layer 68 can be coated the light layer 70, which in one form is a thin (e.g. ~5-100um thick) layer of PDMS with entrained flakes of 158037 Xirallic T60-24 SW Stellar Green produced by Merck KGaA of Darmstadt, Germany. It is contemplated that the Xirallic flakes are oriented substantially aligned to the plane of the surface of the deformable PDMS film. The light layer 70 is in turn coated with a thin (e.g. ~ 10um thick) layer of dye possessing an absorption maximum substantially overlapping with the reflected light spectrum of the Xirallic flake pigment (e.g. in the green) and possessing substantially transmission characteristics in the spectrum which is not strongly reflected by the Xirallic flake (e.g. in the red portion of the spectrum) green dispersed into and immobilized into PDMS. The incorporation of the dye layer enables external green spectrum light to be substantially blocked from reaching the camera thus ensuring that green spectrum light is the result of Xirallic layer reflection and carries information relating to the surface morphology of the tactile stack (and in particular deformations of this surface). In one form the Xirallic and dye layers substantially allow red light to pass through this stack so that light in the red spectrum reaching the camera substantially corresponds to light that has passed through the stack and carries information about objects beyond the tactile stack. In this way the work piece 52 can be imaged as it approaches, but not yet touching, the visual-tactile contact pad 54.

FIG. 3 also discloses multiple lights are provided to aid in illumination of the work piece 52 and pad 54. As will be appreciated given the discussion above, the lights can be housed within the device 50. In some cases these lights may be configured in different positions to provide different lighting conditions for imaging the tactile surface and objects 52 beyond the tactile surface. In some cases these lights may be disposed to provide lighting from opposite sides of the camera so that the structure of illuminated and darkened regions (shadows) provides further information on the surface deformation. The light sources can be placed any distance away from one another and at any spacing suitable relative to the viewing window of the camera 56. The lighting sources can be arranged to project toward each other. The projection can, but need not, be at common angles. The lights can, but need not, project common intensity (lumens). The lights can, but need not, project at common wavelengths. Any variation of the above parameters (orientation, angles, lumens, wavelengths) are contemplated herein.

In some cases these lighting conditions are provided as a sequential series of illumination (e.g. blinking) provided from alternating lighting sources so that multiple lighting conditions can be utilized to maximize the processable information and the camera can obtain distinguishing light information in both spectral and temporal channels. Thus, the lights can be activated in an ON-OFF sequence which, in some forms, are coordinated with each other. To set forth just one non-limiting example, a first light can be activated to the ON condition while the second light is deactivated to the OFF condition, whereupon after an interval of time (which can be predetermined or determined as a result of system processing) the condition reversed with the first light deactivated to OFF while the second light is activated to ON. The above-described process can be repeated with the same or different interval. Such alternating can be sequences which results in a blinkering of lights.

The lighting system 58 (either a single light source or multiple light sources) can be structured to emit light (electromagnetic radiation) at a single wavelength or a range of wavelengths. As used herein the term “emit” or “emitting” or “emanate” or “emanating” is used to describe a process by which a material can either reflect light produced from another source, can produce light itself (e.g. infrared radiation if heated), or can be excited to produce light (e.g. fluorescence). To set forth just one example, a light source can be structured to emit light at a wavelength visible to a human eye (e.g. “visible light”), at infrared or near-infrared wavelengths, a combination of the same, or any other suitable wavelength(s). In some forms the lighting system can include a single light source capable of emitting any of the aforementioned wavelengths and/or ranges. In other forms multiple light sources can be used to emit light at any of the aforementioned wavelengths and/or ranges (which sources can emit at the same wavelengths and/or ranges or can overlap in at least some of the wavelengths and/or ranges). In some forms the lighting system can include an artificial light directly coupled with the imaging system described herein, as well as ambient sunlight, or any other source of light that may not be directly coupled to the imaging system described herein.

As discussed elsewhere in the present disclosure, variations of the lighting system 58 discussed with respect to FIG. 3 are also contemplated with the other embodiments.

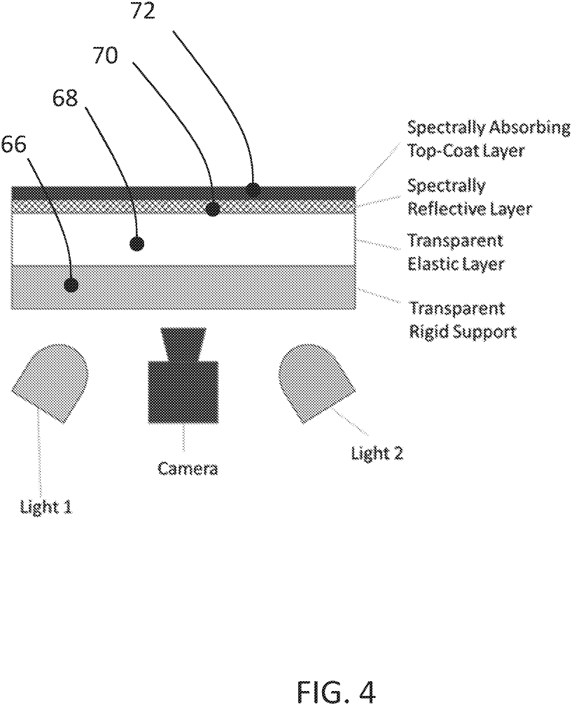

FIG. 4 discloses different compositions of the layers of the pad 54 relative to that depicted in FIG. 3.

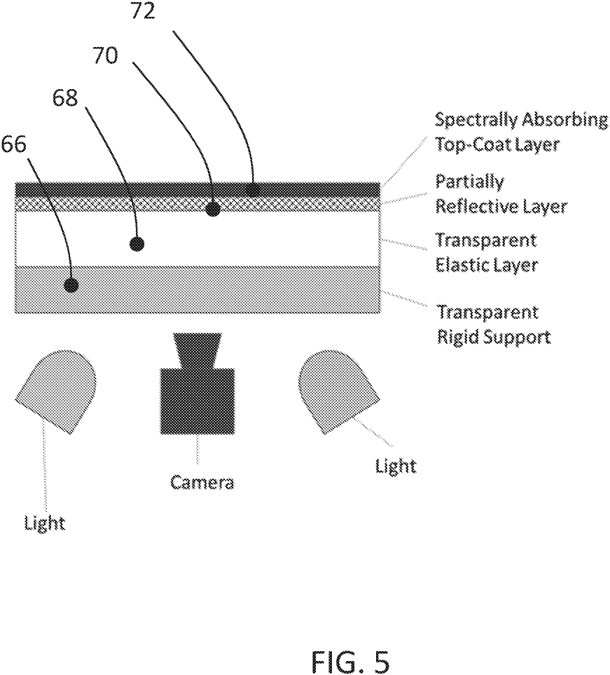

In another embodiment, FIG. 5, a surface dye layer 72 which is selective for absorbing certain parts of the spectrum imaged by the camera while transmitting others is utilized and under this layer a layer of non-selective optically scattering particles (such as nickel microparticles) which are arranged in a morphological density so that the layer provides both substantial back-reflection and also allows substantial transmission of light through this layer. In this case the reflected and transmitted light are separable according to color to distinguish between the two information channels.

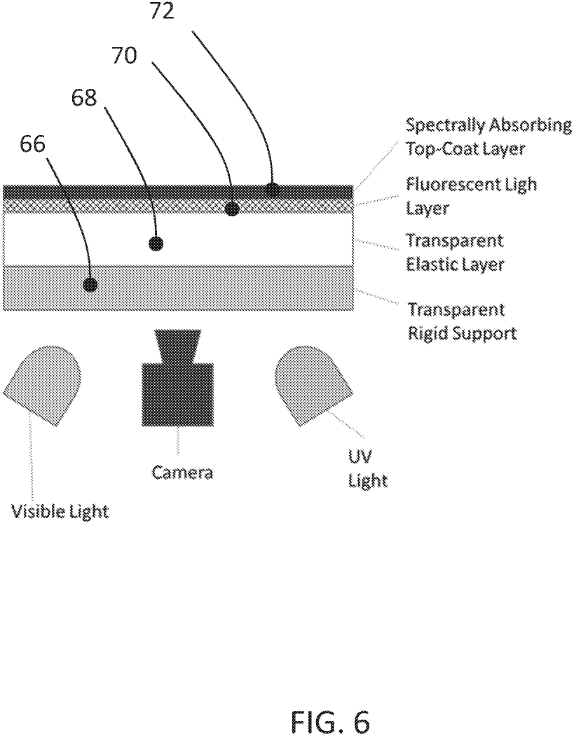

In another embodiment, FIG. 6, a surface dye layer 72 which is selective for absorbing certain parts of the spectrum imaged by the camera while transmitting others is utilized and under this layer a layer 70 containing fluorescent material which fluoresce in a particular spectrum which substantially corresponds to the some portion of the spectrum which is absorbed by the surface dye layer 72 and wherein a suitable illumination source is utilized to excite the fluorescent layer (e.g. in the UV) to provide illumination for the camera and wherein additional lighting may be provided in other wavelengths to enable the visual imaging of objects 52 beyond the dye layer 72. In this case the fluorescent and transmitted light are separable according to color to distinguish between the two information channels.

In yet another embodiment, a surface or near surface a layer 70 containing fluorescent material which fluoresces and wherein a suitable illumination source 58 is utilized to excite the fluorescent layer (e.g. in the UV) to provide illumination for the camera and wherein additional lighting may be provided in other wavelengths to enable the visual imaging of objects beyond the dye layer. And wherein the illumination source is temporally modulated in a determined matter (e.g. blinked) and the differential signal between the illuminated & fluorescing state versus the non-fluorescing state is utilized to obtain information regarding surface information from the fluorescence-derived light versus light that originates from beyond the fluorescent layer. In some cases another layer is incorporated over the top of the fluorescent layer to prevent exciting light from impinging upon the fluorescent layer from above. In this case the fluorescent and transmitted light are separable according to time signature to distinguish between the two information channels. Although the lights can be activated as described above in this embodiment, it will be appreciated that any of the other embodiments may also have lights activated in this manner.

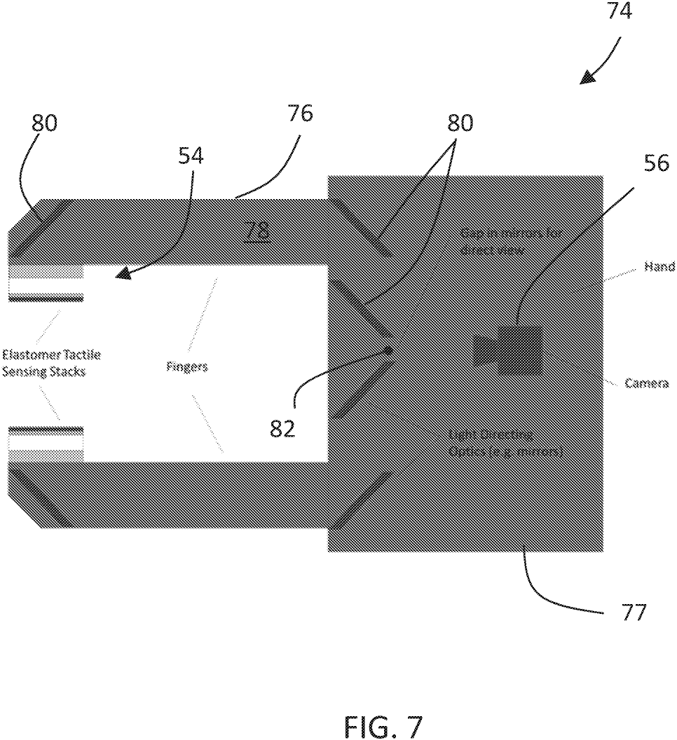

Turning now to FIG. 7, a robotic gripper 74 is illustrated which includes any of the embodiments of the visual-tactile contact pad 54 discussed above, including any associated equipment such as lighting 58, etc. The robotic gripper 74 includes two effectors in the form of fingers 76. The fingers 76 are moveable between at least two positions, and in some forms are moveable to any intermediate position between the two positions. One or more actuators and associated mechanical linkage(s) can be used to move the fingers 76 relative to the hand 77. Furthermore, the fingers 76 can be a single finger section, or can have any number of sections that are connected together such as, but not limited to, through a hinge mechanism. In other embodiments, one or more of the fingers 76 may have mechanical arrangement that permits telescoping extension and retraction. Though the fingers 76 are illustrated as being of similar shape, it will be appreciated that the fingers 76 in any given embodiment of the gripper 74 can be the same or can be different.

An optical path 78 is provided between the visual-tactile contact pads 54 and the camera 56 (which includes an image sensor). The path 78 includes at least one, and in the illustrated embodiment several optical elements which aid in directing and/or focusing optical information from the pad 54 to the cameral 56. The illustrated embodiment includes a series of mirrors 80 arranged between the pad 54 and camera 56 to direct optical information between the two. In some embodiments one or more lenses could also be used. In some forms the optical path 78 includes a fiber optic cable between the pad 54 and camera 56, which in some forms can be supplemented by any number of lenses, mirrors, etc.

The gripper 74 can be arranged to collect image data from the various pads 54 simultaneously or at different times. For example, the image sensor of the camera 56 can be arranged to detect wavelengths projected from respective pads 54, where each pad 54 is configured to project a unique wavelength. In another example, one or more shutters can be used to alternate which of the pads 54 are allowed to project optical data to the image sensor. In still other forms, the gripper 74 can be arranged such that each pad 54 projects an image to a distinct area of the image sensor of the camera 56, thus ensuring that both pads 54 project at the same time and potentially using the same wavelength.

The illustrated embodiment also depicts a gap 82 between optical elements associated with different pads 54. Such a gap 82 can permit direct imaging from the work piece 52 to the camera 56. Similar to variations discussed above, the direct optical path (or an optical path direct from the work piece that is supplemented with mirrors and/or lenses) can provide optical information to the image sensor associated with the camera to permit simultaneous imaging or imaging at different times as described above (e.g. separate wavelengths, separate areas of the imaging sensor, different time through shuttering of the optical paths).

In embodiments disclosed herein, tactile sensing is achieved through the use of transparent deformable gel surfaces (of the pad 54) containing visualization elements which are imaged by an underlying camera system which is constructed so that the camera 56 is distal from the gel surface and light is transported from the gel surface to the camera system by optical elements and generally wherein the relative positions of the camera to the tactile surface may change but wherein imaging is still effective so that the camera can be located “in the hand” while the tactile surfaces are on the “fingers” which can move relative to the hand but wherein imaging still provides tactile sensing.

Tactile sensing is achieved herein through the use of transparent deformable gel surfaces (54) containing visualization elements which are imaged by an underlying camera system which is constructed so that the camera is distal from the gel surface and light is transported from the gel surface to the camera system by optical elements. The relative positions of the tactile surface and the imaging camera 56 may be non-fixed so that the tactile surface may change relative to the position of the camera. This may be achieved by elements such as periscopic mirror systems, or optical fibers.

In preferred embodiments, the system may possess multiple finger manipulator elements 76 each of which will possess a tactile gel surface and wherein the light from these surfaces is directed back onto the same camera 56 so that fewer cameras are needed than there are tactile surfaces (ideally only 1 camera). For instance, this may be achieved wherein each of these tactile view fields are projected onto different portions of the camera sensor.

In some embodiments, the camera system one or more portions of the camera view field will be constructed in such a way that they do not image tactile sensor gel surfaces but image some part of the external environment directly.

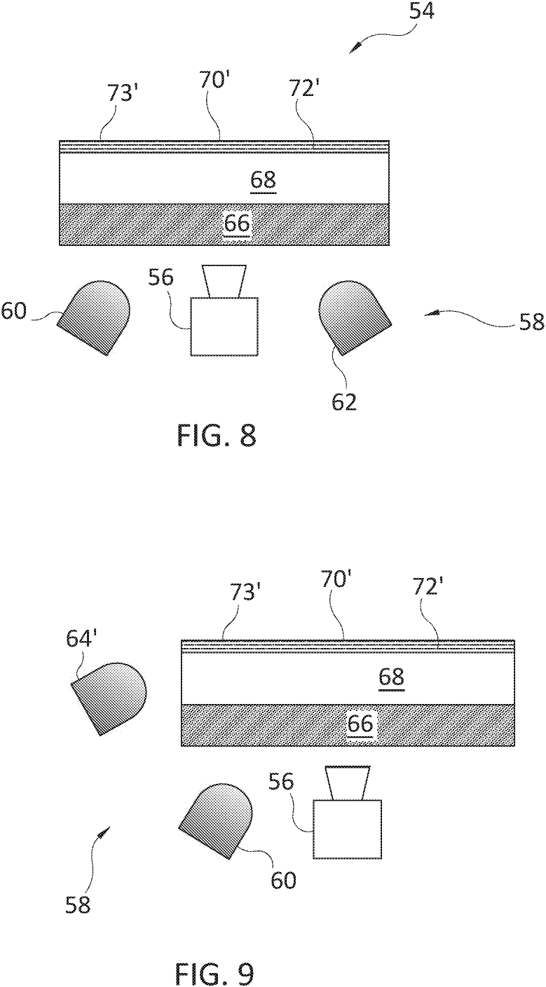

Turning now to FIG. 8, and with continued reference to earlier figures such as but not limited to FIG. 1, the visual-tactile contact pad 54 may be constructed in such a way that certain wavelengths of light are diffracted at different angles of the contact pad 54 surface relative to the angle of camera 56. Embodiments disclosed herein include a rigid base 66, elastic layer 68, and diffraction layer 70′. Diffraction layer 70′ may be provided as a separate layer of elastic material having one or more diffraction elements embedded therein. Diffraction layer 70′ may also be provided as a complete plane or sheet of diffractive material in other embodiments.

Although the camera 56 in FIG. 8 is shown oriented to capture a direct image of the pad 54, other embodiments can include the camera 56 displaced relative to the pad 54 and may be provided an image through reflective techniques (e.g. mirrors) or through a fiber optic cable. Such variations also apply to all other embodiments disclosed herein. As will be understood, the term “camera” can refer to a variety of devices capable of detecting electromagnetic radiation and colorimetric features of diffracted light, whether in the visible range, infrared range, etc. Such “cameras” can also refer to 2D and/or 3D cameras.

In one or more of the embodiments herein tactile sensing by sensing device 50 can be created through a variety of mechanisms. For instance, individual diffraction markers 72′ can be embedded in a layer of the pad 54 so that colorimetric features of the individual diffraction markers 72′ vary with the angle of the rays of the incoming light from lights 60, 62 and/or camera 56. The diffraction markers 72′ may possess diffractive elements, such as small areas or regions of holographic foil in circular shapes or other predetermined shapes. The deformation field of the surface of the elastic layer 68 can be more accurately assessed by visual methods by analyzing the apparent color of the marker(s) 72′ along with other visual parameters associated with marker(s) 72′, including one or more of its apparent position, apparent size, apparent shape, and apparent focal quality, for example.

The diffraction markers 72′ can be incorporated into a diffraction layer 70′ at the top of the elastic layer 68 of pad 54 in order to protect the markers 72′ and prevent them from being damaged or removed from the elastic layer 68. For example, the diffraction markers 72′ may be embedded in a thin diffraction layer 70′ comprised of elastic material that is supported by a primary, thicker elastic layer 68 of elastic material, which is supported on a rigid transparent base 66. In some embodiments, the diffraction markers 72′ can be constructed as relatively small flakes of diffractive material. The small size of the diffractive material comprising the flakes enables the flakes to act as markers to report on surface deformation of pad 54 while minimally impacting the dynamics of the surface deformation due to differential mechanical properties of the flakes relative to the elastic layer 68.

In certain embodiments, one or more of the diffraction markers 72′ is comprised of holographic foil flakes having a circular shape to report on the surface deformation features and/or characteristics of pad 54. In some embodiments, the flakes can be provided with diameters as small 10 micrometers. In other embodiments, the flakes can be provided with diameters as small as 3 micrometers. The flakes may be constructed as diffractive reflectors where the diffraction is produced by features which are located in a plane of the surface of the flake extending along the contact surface 73′ of pad 54. In another embodiment, one or more markers 72′ can be provided as one or more particles with one or more flakes affixed to a side of the particle so that the diffraction is produced by features arranged or constructed normal to the surface of the marker 72′ and/or the contact surface 73′ of contact pad 54. For example, the markers can be arranged or constructed to produce diffraction by metal flakes with a Bragg-type dielectric stack on top of the elastic layer 68, such as Xirallic type particles affixed to metal flakes on one side.

In some embodiments the lighting supplied by lighting system 58 can take the form of a spectral continuum. In some alternative embodiments, the lighting supplied by lighting system 58 may take the form of a set of discrete spectral features. In some embodiments the lighting supplied by lighting system 58 may take a geometric form to control the angular distribution of light which is incident on the diffractive features. For instance, the lighting may be provided as a single point-like light source located at a particular point, or an annulus-shaped light-source, or as a substantially collimated lighting source.

In some embodiments, multiple independent lighting sources such as lights 60, 62 may be supplied which may be used to provide independent illumination controlled to occur in time sequence to be able to obtain colorimetric information relating to the surface deformation under various surface conditions. In certain embodiments, the color-shift as a function of angle will be chosen to match the anticipated angular deformation of the tactile sensor 50 and the lighting supplied, such as shown for light 64′ in FIG. 9.

In the illustrated embodiment the rigid base 66 takes the form of a hard, transparent plate of polycarbonate which supports the elastic layer 68. The rigid base 66 can take other forms as will be appreciated. The elastic layer 68 takes the form of a deformable film of polydimethylsiloxane (PDMS). The elastic layer 68 can support the diffraction layer 70′. In one form the base 66, elastic layer 68, and diffraction layer 70′ substantially allow at least some light to pass through this stack so that light reaching the camera 56 substantially corresponds to light that has passed through the stack of layers and carries information about objects beyond the pad 54. In this way the work piece 52 can be imaged as it approaches, but not yet touching, the visual-tactile contact pad 54.

FIGS. 2 and 3 also disclose multiple lights 60, 62 that are provided to aid in illumination of the work piece 52 and pad 54. As will be appreciated given the discussion above, the lights can be housed within the device 50. In some cases these lights may be configured in different positions to provide different lighting conditions for imaging the tactile surface and objects 52 beyond the tactile surface, such as shown with light 64′ in FIG. 9. In some cases these lights may be disposed to provide lighting from opposite sides of the camera 56 as shown in FIG. 8 so that the structure of illuminated and darkened regions (shadows) provides further information on the surface deformation.

The lights 60, 62 can be placed any distance away from one another and at any spacing suitable relative to the viewing window of the camera 56. The lights 60, 62 can be arranged to project toward each other. The projection can, but need not, be at common angles. The lights can, but need not, project common intensity (lumens). The lights can, but need not, project at common wavelengths. Any variation of the above parameters (orientation, angles, lumens, wavelengths) are contemplated herein.

In some cases these lighting conditions are provided as a sequential series of illumination (e.g. blinking) provided from alternating lights 60, 62 so that multiple lighting conditions can be utilized to maximize the processable information and the camera 56 can obtain distinguishing light information in both spectral and temporal channels. Thus, the lights 60, 62 can be activated in an ON-OFF sequence which, in some forms, are coordinated with each other. To set forth just one non-limiting example, a first light 60 can be activated to the ON condition while the second light 62 is deactivated to the OFF condition, whereupon after an interval of time (which can be predetermined or determined as a result of system processing) the condition reversed with the first light 60 deactivated to OFF while the second light 62 is activated to ON. The above-described process can be repeated with the same or different interval. Such alternating can be sequences which results in a blinkering of lights 60, 62.

The lighting system 58 (either a single light source or multiple light sources 60, 62) can be structured to emit light (electromagnetic radiation) at a range of wavelengths. As used herein the term “emit” or “emitting” or “emanate” or “emanating” is used to describe a process by which a material can either reflect light produced from another source, can produce light itself (e.g. infrared radiation if heated), or can be excited to produce light (e.g. fluorescence). To set forth just one example, a light 60, 62 can be structured to emit light at wavelengths visible to a human eye (e.g. “visible light”), at infrared or near-infrared wavelengths, a combination of the same, or any other suitable wavelength(s). In some forms the lighting system 58 can include a single light source capable of emitting any of the aforementioned wavelengths and/or ranges. In other forms multiple light sources can be used to emit light at any of the aforementioned wavelengths and/or ranges (which sources can emit at the same wavelengths and/or ranges or can overlap in at least some of the wavelengths and/or ranges). In some forms the lighting system 58 can include an artificial light directly coupled with the imaging system described herein, as well as ambient sunlight, or any other source of light that may not be directly coupled to the imaging system described herein.

It will be appreciated that the embodiments of the contact pad 54 described in FIGS. 8 and 9 are applicable for use with the robotic gripper embodiments described above, such as in FIG. 7. In addition, it will be appreciated that the description of any element having like reference numerals described herein (e.g. elastic layer 68, lighting system 58, camera 56, etc) with respect to any given figure will be understood to apply to any of the other figures unless expressly disclaimed to the contrary.

One aspect of the present application provides an apparatus comprising a robotic visual tactile device having an end effector that includes a plurality of effectors each structured to engage a work piece, the robotic visual tactile device also including an image sensor structured to capture visual data related to engagement of the plurality of effectors to the work piece, the robotic visual tactile device having: a plurality of visual-tactile contact pads wherein a visual-tactile contact pad of the plurality of visual-tactile contact pads is integrated with each effector of the plurality of effectors; and an optical path associated with each of the visual-tactile contact pads integrated with its associated effector, the optical path connecting the visual-tactile contact pads with the image sensor; wherein the image sensor is useful to generate visual data associated with each of the optical paths.

A feature of the present application includes wherein the image sensor is a single sensor.

Another feature of the present application includes wherein each of the optical paths include at least one mirror.

Still another feature of the present application includes wherein each of the optical paths include a plurality of mirrors.

Yet another feature of the present application includes wherein a separate optical path is defined between the work piece and the image sensor independent of each of the visual-tactile contact pads, and wherein the image sensor is useful to generate visual data associated with each of the optical paths and the separate optical path.

Still yet another feature of the present application includes wherein each effector of the plurality of effectors is movable between a first position and a second position, wherein each optical path is structured to move with movement of each effector, and wherein each optical path is structured to remain connected with the image sensor at the first position and the second position.

Yet still another feature of the present application further includes a controller structured to regulate operation of the robotic visual tactile device, and wherein the controller is structured to regulate operation of the image sensor.

A further feature of the present application includes wherein each of the visual-tactile contact pads of the plurality of visual-tactile contact pads is constructed to project light at wavelengths distinct from each other such that the image sensor is capable of distinguishing light data from the respective visual-tactile contact pads.

Another aspect of the present application provides a method comprising: moving a plurality of effectors of a robotic end effector into engagement with a work piece, each of the plurality of effectors having a visual-tactile contact pad structured to deform upon contact with the work piece and provide optical date representative of a contour of the work piece; conveying optical data associated with each of the visual-tactile contact pads via an optical path connected between each of the visual-tactile contact pads and the image sensor; and capturing the optical data conveyed via the optical path with the image sensor for each of the visual-tactile contact pads.

A feature of the present application further includes capturing image data with the image sensor independent of the visual-tactile contact pads.

Another feature of the present application includes wherein the capturing image data occurs in a direct optical path located between a first optical path associated with a first visual-tactile contact pad of the plurality of visual-tactile contact pads and a second optical path associated with a second visual-tactile contact pad of the plurality of visual-tactile contact pads.

Yet another feature of the present application includes wherein the conveying includes transmitting light at separate frequencies from each of the visual-tactile contact pads such that the capturing includes capturing light at the separate frequencies at the image sensor from each of the visual-tactile contact pads.

Still another feature of the present application includes wherein the conveying includes reflecting light projecting from the visual-tactile contact pad along the optical path using a plurality of mirrors.

Yet still another feature of the present application further includes maintaining the optical path during the moving from a first position to a second position.

Still another aspect of the present application includes an apparatus comprising: a robotic gripper having multiple fingers each of the fingers having a visual-tactile contact pad structured to deform upon contact with a work piece and project a light corresponding to a contour of the work piece when contacted, the robotic gripper including a single image sensor structured to receive the light projected from visual-tactile contact pad when illuminated by a light source, the single image sensor capable of imaging the contour from each of the visual-tactile contact pads when light.

A feature of the present application includes wherein the light projected from a first visual-tactile contact pad is at a different wavelength than the light projected from a second visual-tactile contact pad.

Another feature of the present application includes wherein the image sensor is structured to receive light projected from the work piece without passing through any visual-tactile contact pad.

Still another feature of the present application includes wherein at least one of the fingers of the multiple fingers is structured to be moveable, and wherein the robotic gripper is structured to maintain an optical path from the visual-tactile contact pad to the image sensor during movement of the at least one of the fingers.

Yet another feature of the present application further includes plurality of mirrors associated with the optical paths from each of the visual-tactile contact pads to the image sensor.

Still yet another feature of the present application includes wherein the image sensor is positioned to receive light directly from the work piece in an optical path located between a first finger and a second finger.

Yet another aspect of the present application provides a method comprising: imaging a work piece with a camera associated with a robotic gripper that includes a visual-tactile contact pad integrated with each of a plurality of fingers; determining an orientation of the work piece relative to a finger of the plurality of fingers of the robotic gripper; orienting the finger to position the work piece in a gripping position based on the determining; and gripping the work piece between a visual-tactile contact pad of the finger and another finger of the plurality of fingers at a desired force after the orienting.

A feature of the present application includes wherein the imaging includes providing a pre-contact image of the work piece through the visual-tactile contact pad.

Another feature of the present application includes wherein the imaging includes providing a pre-contact image of the work piece through a gap provided between fingers of the robotic gripper.

Still another feature of the present application further includes determining a contact force of the finger.

Yet another feature of the present application includes wherein the another finger includes a visual-tactile contact pad such that the work piece is positioned between visual-tactile contact pads of each of the fingers.

Still yet another feature of the present application includes wherein the imaging includes providing a pre-contact image of the work piece through the visual-tactile contact pads associated with the finger and the another finger.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. An apparatus comprising:
a robotic visual tactile device having an end effector that includes a plurality of effectors each structured to engage a work piece, the robotic visual tactile device also including an image sensor structured to capture visual data related to engagement of the plurality of effectors to the work piece, the robotic visual tactile device having:
a plurality of visual-tactile contact pads wherein a visual-tactile contact pad of the plurality of visual-tactile contact pads is integrated with each effector of the plurality of effectors; and
an optical path associated with each of the visual-tactile contact pads integrated with its associated effector, the optical path connecting the visual-tactile contact pads with the image sensor;
wherein the image sensor is useful to generate visual data associated with each of the optical paths.

2. The apparatus of claim 1, wherein the image sensor is a single sensor.

3. The apparatus of claim 1, wherein each of the optical paths include at least one mirror.

4. The apparatus of claim 3, wherein each of the optical paths include a plurality of mirrors.

5. The apparatus of claim 3, wherein a separate optical path is defined between the work piece and the image sensor independent of each of the visual-tactile contact pads, and wherein the image sensor is useful to generate visual data associated with each of the optical paths and the separate optical path.

6. The apparatus of claim 1, wherein each effector of the plurality of effectors is movable between a first position and a second position, wherein each optical path is structured to move with movement of each effector, and wherein each optical path is structured to remain connected with the image sensor at the first position and the second position.

7. The apparatus of claim 1, which further includes a controller structured to regulate operation of the robotic visual tactile device, and wherein the controller is structured to regulate operation of the image sensor.

8. The apparatus of claim 1, wherein each of the visual-tactile contact pads of the plurality of visual-tactile contact pads is constructed to project light at wavelengths distinct from each other such that the image sensor is capable of distinguishing light data from the respective visual-tactile contact pads.

9. A method comprising:
moving a plurality of effectors of a robotic end effector into engagement with a work piece, each of the plurality of effectors having a visual-tactile contact pad structured to deform upon contact with the work piece and provide optical date representative of a contour of the work piece;
conveying optical data associated with each of the visual-tactile contact pads via an optical path connected between each of the visual-tactile contact pads and the image sensor; and
capturing the optical data conveyed via the optical path with the image sensor for each of the visual-tactile contact pads.

10. The method of claim 9, which further includes capturing image data with the image sensor independent of the visual-tactile contact pads.

11. The method of claim 10, wherein the capturing image data occurs in a direct optical path located between a first optical path associated with a first visual-tactile contact pad of the plurality of visual-tactile contact pads and a second optical path associated with a second visual-tactile contact pad of the plurality of visual-tactile contact pads.

12. The method of claim 9, wherein the conveying includes transmitting light at separate frequencies from each of the visual-tactile contact pads such that the capturing includes capturing light at the separate frequencies at the image sensor from each of the visual-tactile contact pads.

13. The method of claim 9, wherein the conveying includes reflecting light projecting from the visual-tactile contact pad along the optical path using a plurality of mirrors.

14. The method of claim 9, which further includes maintaining the optical path during the moving from a first position to a second position.

15. An apparatus comprising:
a robotic gripper having multiple fingers each of the fingers having a visual-tactile contact pad structured to deform upon contact with a work piece and project a light corresponding to a contour of the work piece when contacted, the robotic gripper including a single image sensor structured to receive the light projected from visual-tactile contact pad when illuminated by a light source, the single image sensor capable of imaging the contour from each of the visual-tactile contact pads when light.

16. The apparatus of claim 15, wherein the light projected from a first visual-tactile contact pad is at a different wavelength than the light projected from a second visual-tactile contact pad.

17. The apparatus of claim 15, wherein the image sensor is structured to receive light projected from the work piece without passing through any visual-tactile contact pad.

18. The apparatus of claim 15, wherein at least one of the fingers of the multiple fingers is structured to be moveable, and wherein the robotic gripper is structured to maintain an optical path from the visual-tactile contact pad to the image sensor during movement of the at least one of the fingers.

19. The apparatus of claim 18, which further includes plurality of mirrors associated with the optical paths from each of the visual-tactile contact pads to the image sensor.

20. The apparatus of claim 19, wherein the image sensor is positioned to receive light directly from the work piece in an optical path located between a first finger and a second finger.
